(19) United States
(12) Patent Application Publication
(10) Pub. No.: US 2004/0208948 A1
(43) Pub. Date: Oct. 21, 2004

(54) Molding apparatus for press-forming

(76) Inventor: Jong-Ho Lee, Suwon city (KR)

Correspondence Address: CANTOR COLBURN, LLP, 55 GRIFFIN ROAD SOUTH, BLOOMFIELD, CT, 06002

(21) Appl. No.: 10/720,645

(22) Filed: Nov. 24, 2003

(30) Foreign Application Priority Data
Apr. 16, 2003 (KR) 2003-24155

(51) Int. Cl. B29C 43/50

(52) U.S. Cl. 425/422; 425/DIG. 58

(57) ABSTRACT

A molding apparatus for press-forming for providing a core material with a step comprising a frame; a die provided on the frame, and on which a core material mounted; a stripper pressing and releasing the core material mounted on the die by moving toward or away from the die; a punch holder disposed on an upper part of the stripper, and supporting a punch which forms a step in the core material; a press slide moving the punch holder toward or away from the die; a linear motor reciprocating linearly and controlling a position of the die; and a linear joint block connecting the die and the linear motor, and transmitting the linear reciprocation of the linear motor to the die. With this configuration, the molding apparatus for press-forming is capable of manufacturing a product having a step with high precision, and extending its life expectancy.

### CROSS-REFERENCE TO RELATED APPLICATIONS

This application claims the benefit of Korean Patent Application No. 2003-24155, filed 16 Apr., 2003, in the Korean Intellectual Property Office, the disclosure of which is incorporated herein by reference.

### BACKGROUND OF THE INVENTION

1. Field of the Invention

The present invention relates to a molding apparatus for press-forming, and more particularly, a molding apparatus for press-forming, which is capable of forming a material to have a step.

2. Description of the Related Art

In general, to produce a laminated motor core having a step, a material for the motor core is press-formed to have a step therein using a molding apparatus for press-forming, and then a plurality of core materials are slantingly laminated and assembled into the motor core.

FIG. 4 shows a vertical section view of a conventional molding apparatus for press-forming. As shown therein, the conventional molding apparatus for press-forming has a molding apparatus 110 plurally disposed on a frame 111 in parallel to press-form a core material so that the core material is pressed, forming a desirable step. Each of the molding apparatus 110 comprises a die 121 provided on the frame 111, and on which the core material is mounted; a stripper 141 pressing the core material by moving toward the die 121, or releasing the core material by moving away from the die 121; a punch holder 151 disposed above the stripper 141 and supporting a punch 155 forming a step in the core material; a press slide 171 moving the punch holder 151 toward or away from the die 121; a rotational servo motor 175 controlling a position of the die 121 on the frame 111; and a ball screw 177 connecting the die 121 and the servo motor 175, and converting the rotation of the servo motor 175 into linear motion.

Also, in the conventional molding apparatus for press-forming, the die 121 moves sliding along an upper side of a guide 113 supported by a guide block 115 provided on the frame 111, and scraps (not shown) generated after a press-forming process, are discharged outside by a scrape discharger with a vibration motor.

With the above configuration, when a servo motor of each of molding apparatus is operated, rotation of the servo motor causes a ball screw to turn spirally moving a die linearly to a predetermined position, and then a press moves down toward the die to punch the core material mounted on the die, and thus the core material having a predetermined step is produced.

However, in the conventional molding apparatus for press-forming, the ball screw which rotates spirally triggers the die of to move reciprocatedly, and the spiral rotation of the ball screw causes a backlash (about 0.005 mm˜0.02 mm) thereof, resulting in a low precision in manufacturing products, and other problem is that the amount of backlash of the ball screw is increased because of a long period of continuous partial operation of the die. Thus, the conventional molding apparatus for press-forming is inappropriate for a long-term manufacturing of a product having a high precision step.

Also, in the conventional molding apparatus for press-forming, there is additionally needed a scrap discharger to discharge scrapes generated after a punching process.

### SUMMARY OF THE INVENTION

Accordingly, it is an aspect of the present invention to provide a molding apparatus for press-forming capable of manufacturing a product having a step with high precision, and extending its life expectancy.

Further, the molding apparatus for press-forming according to the present invention does not require an additional scrap discharger to discharge scraps generated after a punching process.

The foregoing and/or other aspects of the present invention are also achieved by providing a molding apparatus for press-forming for providing a core material with a step comprising a frame; a die provided on the frame, and on which a core material mounted; a stripper pressing and releasing the core material mounted on the die by moving toward or away from the die; a punch holder disposed on an upper part of the stripper, and supporting a punch which forms a step in the core material; a press slide moving the punch holder toward or away from the die; a linear motor reciprocating linearly and controlling a position of the die; and a linear joint block connecting the die and the linear motor, and transmitting the linear reciprocation of the linear motor to the die.

According to an aspect of the present invention, the die and the frame have scrap discharging holes to discharge out scraps generated after a punching process by the punch.

### BRIEF DESCRIPTION OF THE DRAWINGS

The above and/or other aspects and advantages of the present invention will become apparent and more readily appreciated from the following description of the embodiments, taken in conjunction with the accompany drawings of which:

FIG. 1 is a schematic plan view of a molding apparatus for press-forming according to an embodiment of the present invention;

FIG. 2 is a longitudinal section view of a side of the molding apparatus for press-forming in FIG. 1;

FIG. 3 is a longitudinal section view of an operation of the molding apparatus for press-forming in FIG. 1; and

FIG. 4 is a schematic longitudinal section view of a conventional molding apparatus for press-forming.

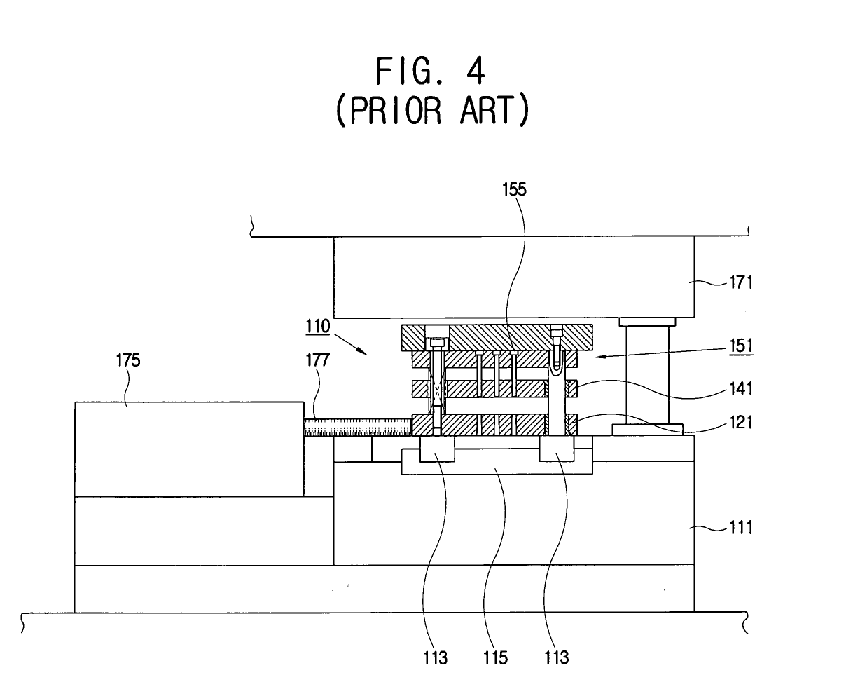

### DETAILED DESCRIPTION OF THE PREFERRED EMBODIMENT

Reference will now be made in detail to the embodiments of the present invention, examples of which are illustrated in the accompanying drawings, wherein like reference numerals refer to like elements throughout. The embodiments are described below in order to explain the present invention by referring to the figures.

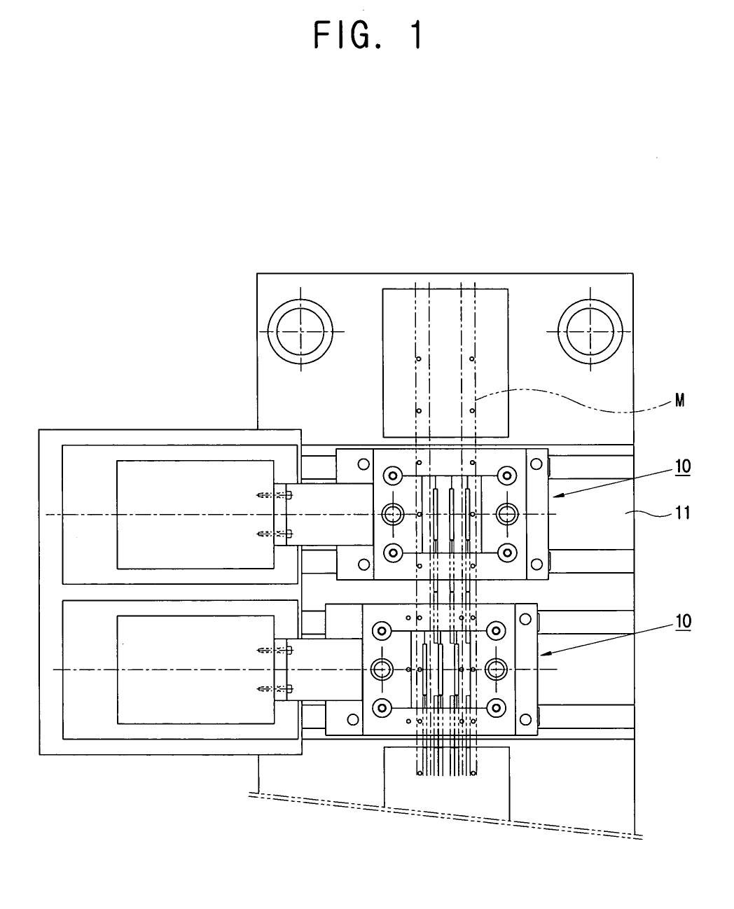

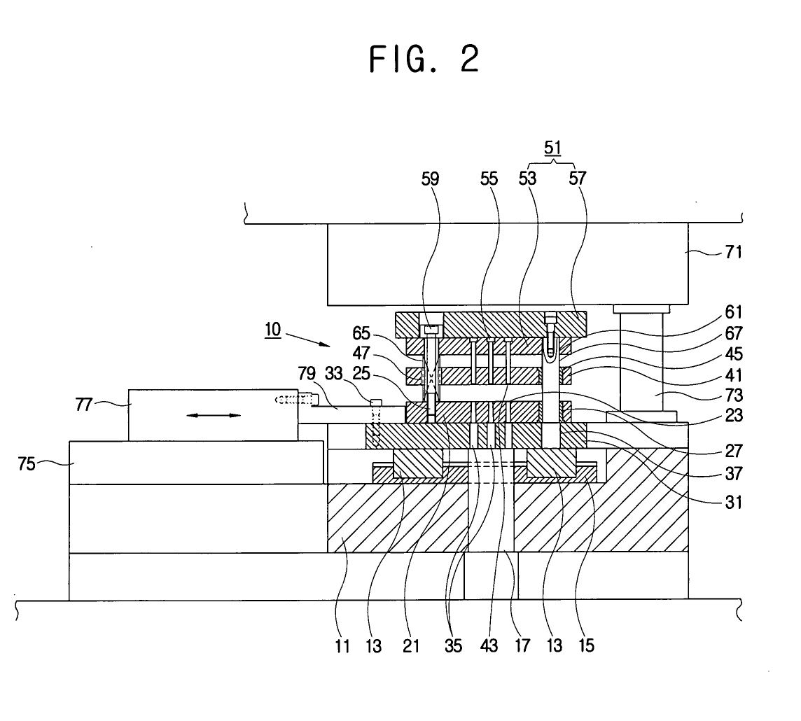

FIG. 1 is a schematic plan view of a molding apparatus for press-forming according to an embodiment of the present invention, and FIG. 2 is a longitudinal section view of a side of the molding apparatus for press-forming in FIG. 1. As shown therein, the molding apparatus for press-forming according to the embodiment of the present invention is formed in a pair of mold apparatus 10 parallely disposed on a frame 11 to press a core material M to be desirably stepped.

As shown in FIG. 2, each of the molding apparatus 10 comprises a die 21 provided on a frame 11 and on which the core material M is mounted; a stripper 41 pressing or releasing the core material M mounted on the die 21 by moving the core material M toward or away from the die 21; a punch holder 51, supporting a punch 55, disposed on an upper part of the stripper 41, forming a step in the core material M; a press slide 71 moving the punch holder 51 toward or away from the die 21; a linear rotational motor 75 controlling a position of the die 21; and a linear joint block 79 connecting the die 21 and the linear motor 75, and transmitting linear rotation of the linear motor 75 to the die 21.

In an upper side of the frame 11 of each of the molding apparatus 10, a pair of guide 13 guiding a sliding linear rotation of a bottom holder 31 (to be described later) is provided, and each of the guides 13 is supported by a guide block 15 provided in a bottom of the frame 11.

Between each of the guides 13, a scrap discharging hole 17 is formed penetrating from a bottom side of the frame 11 to the die 21 to discharge scraps generated after the punching process.

On an upper part of each of the guides 13, the die 21 where the core material is mounted on is provided, and the die 21 has a punching hole 23, which is the same with the punch 55 (to be described later) in size, is provided. The die 21 has a first guide bush 27 which a spring 65 (to be described later) passes through is provided, and a spring support pin 25 supporting an end side of the spring 65 (to be described later) is protruded from an upper side of the die 21.

The linear joint block 79 is connected to a side of the die 21, and a bottom holder 31 supporting the die 21 is provided in a bottom of the die 21.

The bottom holder 31 and the linear joint block 79 are connected by a combining means 33 such as a bolt, and, at the same time, the die 21 and the bottom holder 31 reciprocate linearly along the guide 13 relative to the linear reciprocation of the linear motor 75.

In the bottom holder 21, a plurality of scrap guiding holes 35 is penetratingly provided, guiding the scraps generated after the press-forming process to the scrap discharging hole 17 of the frame 11. The plurality of scrap guiding holes 35 are disposed corresponding to the punching hole 23 of the die 21, and the size of the scrap guiding hole 35 is bigger than that of the punching hole 23 of the frame 11 to discharge the scraps easily. In the bottom holder 31, a guide pin guiding hole 37 is also provided to guide a guide pin 67 (to be described later) to be lifted or moved down during the press-forming process.

On an upper side of the die 21, the stripper 41 is provided to press or release the core material M mounted on the die 21 by moving toward or away from the die 21. Disposed corresponding to the punching hole 23 of the die 21, a plurality of penetrating holes 43 is provided in the stripper 41 and the punch 55 passes therethrough. The stripper 41 further comprises a second guide bush 45 and the guide pin 67 passes therethough; and a spring penetrating hole 47 through which a spring 65 (to be described later) passes.

The punch holder 51 is provided above of the stripper 41 and accommodates and supports a plurality of punches 55. The punch holder 51 comprises a punch plate 53 in which the plurality of punches 55 are accommodated; and an upper holder 57 supporting an upper part of the punch plate 53.

The punch holder 51 is connected to the stripper 41 by a stroke control bolt 59, and comprises a guide pin accommodating hole 61 provided in a side of the punch holder 51 so as to accommodate an end part of the guide pin 67.

Between a bottom side of the punch plate 53 and an upper side of the die 21, the spring 65 is disposed to constantly maintain a certain distance of the punch plate 53 and the die 21. An end side of the spring 65 is supported on an upper part of the die 21 by the spring support pin 25, and, at the same time, the other end side is supported on a bottom part of the punch plate 53. Therefore, if the punch holder 51 is lifted up after the press-forming process, the stripper 41 pressing the core material M on the die 21 during the press-forming process moves away from the die 21 by elasticity of the spring 65 and the stripper 41 returns to its original position.

On the other hand, the punch holder 51, the stripper 41, and the die 21 are connected by the guide pin 67. The guide pin 67 passes through the die 21 and each of the guide bushes 27 and 45 of the stripper 41, and an end of the guide pin 67 is accommodated in the guide pin accommodating hole 61 of the punch holder 51, and the other end is lifted along the guide pin guiding hole 37 of the bottom holder 31 and guides the stripper 41 and the punch holder 51 to be lifted away. Therefore, the die 21 reciprocates linearly causing the stripper 41 and the punch holder 51 moves linearly, at the same time.

The press slide 71 is provided in an upper part of the punch holder 51, and lifted along a main post 73 standing on the frame 11 by a driving means (not shown) and presses the upper part of the punch holder 51 till the punch 55 of the punch holder 51 passes through the punching hole 23 of the die 21, and thereby the press-forming process for the core material M is accomplished.

On the other hand, the molding apparatus for press-forming according to the embodiment of the present invention has the linear motor 75 reciprocating linearly to control the position of the die 21.

The linear motor 75 is provided in a side of the frame 11 adjacent to the bottom holder 31, and has a linear moving block 77 reciprocating linearly by an operation of the linear motor 75. The linear motor 75 controls position as accurate as about 0.002 mm˜0.003 mm, and thus position of the die 21 is more accurately controlled by the linear reciprocation than by the ball screw.

The linear moving block 77 and the die 21 of the linear motor 75 are connected each other by the linear joint block 79, and the linear reciprocation of the linear motor 75 is transmitted to the die 21 through the linear joint block 79, and thus, at the same time, the stripper 41 and the punch holder 51 connected by the guide pin 67 reciprocate linearly as the die 21 reciprocates linearly.

With the above configuration, a process of molding for press-forming is as follows. At first, if the core material M is mounted on an upper side of the die 21 of each of the molding apparatus 10, the linear motor 75 of each of the molding apparatus 10 is driven to differentiate each of distances created by the linear movement of the die 21 of each of the molding apparatus 10, that is, to form a predetermined step in the core material M.

At this moment, the linear movement of the linear motor 75 is transmitted to the die 21 through the linear joint block 79, and at the same time, the stripper 41 and the punch holder 51, connected by the guide pin 67 each other, reciprocate linearly.

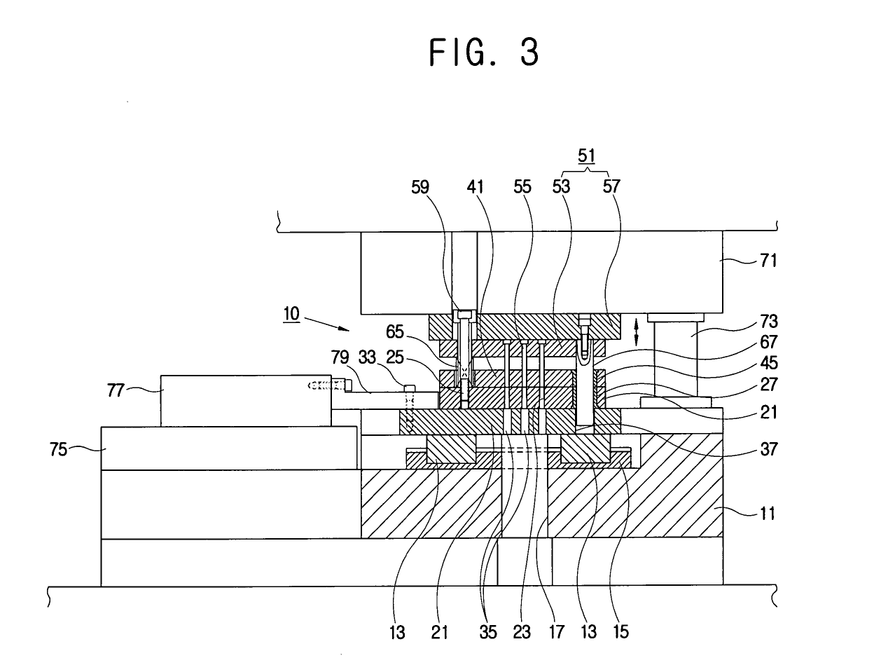

As shown in FIG. 3, the driving means (not shown) moves down the press slide 71 of each of the molding apparatus 10, and thus an upper part of the punch holder 51 is pressed consequently. At this moment, the spring 65 is disposed between the punch holder 51 and the die 21.

As the press slide 71 moves down the punch holder 51, the punch holder 51 and the stripper 41 move down toward the die 21 at the same time, and the stripper 41 presses the core material M mounted on the upper part of the die 21.

If the press slide 71 is more moved down, the punch 55 of the punch holder 51 passes through the punching hole 23 of the die 21 and presses the core material M to form a predetermined step. At this moment, the scraps of the pressed core material M are discharged outside through the scrap discharging hole 17 of the frame 11 via the scrap guide hole 35 of the bottom holder 31.

After the process of molding for press-forming is completed, the press slide 71 is lifted along the main post and releases the punch holder 51 which has been pressed by the driving means.

As the punch holder 51 is being released, the stripper 41 and the punch holder 51 move away from the die 21 and return to their original position by elasticity of the spring 65, and the pressed core material M on the die 21 becomes a product having a high precision step.

Laminating a product having a step through the above process, a motor can have an inclined layered core.

According to the above embodiment of the present invention, a core material can be a product having a high precision step with a die on which the core material mounted linearly reciprocating by a linear motor which precisely controls position relative to the linear reciprocation, and thereby extending life expectancy of a molding apparatus.

In addition, an additional scrap discharging device is needless because a discharging hole to throw out scraps generated after a punching process.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A molding apparatus for press-forming for providing a core material with a step comprising:
a frame;
a die provided on the frame, and on which a core material mounted;
a stripper pressing and releasing the core material mounted on the die by moving toward or away from the die;
a punch holder disposed on an upper part of the stripper, and supporting a punch which forms a step in the core material;
a press slide moving the punch holder toward or away from the die;
a linear motor reciprocating linearly and controlling a position of the die; and
a linear joint block connecting the die and the linear motor, and transmitting the linear reciprocation of the linear motor to the die.

2. The molding apparatus according to claim 1, wherein the die and the frame have scrap discharging holes to discharge out scraps generated after a punching process by the punch.
